(19) United States
(12) Patent Application Publication
(10) Pub. No.: US 2011/0133869 A1
(43) Pub. Date: Jun. 9, 2011

(54) DYNAMIC SEALING DEVICE FOR MIDDLE- OR HIGH-VOLTAGE POWER SWITCH EQUIPMENT

(76) Inventors: Jichun Yan, Hunan (CN); Gongfa Wang, Hunan (CN)

(21) Appl. No.: 12/675,321

(22) PCT Filed: Jun. 6, 2008
(86) PCT No.: PCT/CN2008/071224

§ 371 Date: Feb. 25, 2010

(30) Foreign Application Priority Data
Aug. 31, 2007 (CN) 200710147638.8

(51) Int. Cl. H01H 36/00

(52) U.S. Cl. 335/205

(57) ABSTRACT

Disclosed is a dynamic sealing device for a middle- or high-voltage power switch equipment, comprising: a housing (9), a cover (10) fitted with the housing (9), a main shaft (1) mounted within the housing (9) and coupling an acting mechanism inside an aeration compartment and an operating mechanism outside the aeration compartment, two bearings (3) for mounting the main shaft (1), and at least one permanent magnet (8) and at least two poles (5) being fitted to an inner hole of the housing (9) and having gaps between them and the main shaft (1), wherein, the two poles (5) are located on both sides of the permanent magnet (8) respectively and have a plurality of pole teeth, and magnetic fluid (7) is provided between the pole teeth of the poles (5) and the main shaft (1).

### CROSS REFERENCE TO RELATED APPLICATION

This application claims the benefit of Chinese Patent Application No. 200710147638.8, entitled “DYNAMID SEALING DEVICE FOR MIDDLE-OR HIGH- VOLTAGE POWER SWITCH EQUIPMENT” filed on Aug. 31, 2007 with the State Intellectual Property Office of PRC, which is hereby incorporated by reference in its entirety.

### FIELD OF THE INVENTION

The present invention relates to a sealing device, and in particular, to a dynamic sealing device for a middle- or high-voltage power switch equipment.

### BACKGROUND

Middle- or high-voltage power switch equipments are crucial products in an entire power grid construction. In view of the safety first principle in the use of electricity, using a middle- or- high voltage power switch may cause unsafety and even serious electric power accident due to the electric arc that will be necessarily generated during operation of the middle- or high-voltage power switch.

Various methods have been attempted to provide the middle- or high-voltage power switch with a function of arc extinguishing and insulating. In practice, it has been proved that sulfur hexafluoride (SF₆) gas, which is an internationally recognized non-active gas most suitable for being used as an insulating medium, has the best effect in arc extinguishing and insulating. Therefore, the existing middle- or high-voltage power switch generally uses sulfur hexafluoride (SF₆) gas for arc extinguishing and insulating.

However, since the pressure within the aeration compartment in which sulfur hexafluoride (SF₆) is stored in the middle- or high-pressure power switch equipment is higher than external atmospheric pressure, sulfur hexafluoride (SF₆) as the insulating medium may leak out, resulting in failure of the arc extinguishing and insulating of the middle- or high-voltage power switch equipment. If dynamic sealing in the middle- or high-voltage power switch equipment fails to function, the leakage of insulating gas, i.e. sulfur hexafluoride (SF₆), will necessarily bring about insulating accident, therefore causing large-scale blackout, electrical equipment accident, and even personnel casualty.

Dynamic sealing is named with respect to static sealing between relative statically engaging surfaces, and refers to sealing between relative moving engaging surfaces. Since the sealing required for the aeration compartment of a middle- or high-voltage power switch equipment is a sealing for relative moving engaging surfaces, the dynamic sealing technology relates to an effect of dynamic sealing of the middle- or high-voltage power switch equipment.

From a global perspective, the dynamic sealing for arc extinguishing and insulating medium of the middle- or high-voltage power switch equipment is still made in conventional way. The existing middle- or high-voltage power switch equipment is dynamically sealed by way of sealing with rubber products or bellows sealing, but the sealing effect is not good and it is easy to cause insulating accident and thus large-scale blackout, electrical equipment accident, and even personnel casualty.

Accordingly, at present, a technical problem to be solved by persons skilled in the art is how to provide a dynamic sealing device for a middle- or high-voltage power switch equipment that satisfies requirements for dynamic sealing of sulfur hexafluoride (SF₆) as insulating medium of the middle- or high-voltage power switch equipment.

### SUMMARY OF THE INVENTION

The technical problem to be solved by the present invention is to provide a dynamic sealing device for a middle- or high-voltage power switch equipment that can meet requirements for dynamic sealing of insulating medium of the middle- or high-voltage power switch equipment.

Specifically, the present invention provides a dynamic sealing device for a middle- or high-voltage power switch equipment, characterized by comprising: a housing, a cover fitted with the housing, a main shaft mounted within the housing and coupling an acting mechanism inside an aeration compartment and an operating mechanism outside the aeration compartment, two bearings for mounting the main shaft, and at least one permanent magnet and at least two poles being fitted to an inner hole of the housing and having gaps between them and the main shaft, wherein, the two poles are located on both sides of the permanent magnet respectively and have a plurality of pole teeth, and magnetic fluid is provided between the pole teeth of the poles and the main shaft.

Preferably, the pole has pole teeth on the inner surfaces thereof on a side close to the main shaft, and the magnetic fluid is located between the pole teeth and the main shaft.

Preferably, the poles are provided, at outer surfaces thereof on a side close to the inner hole of the housing, with an annular groove into which an O-like sealing ring is mounted.

Preferably, the housing further includes a flange integral with the housing, the flange is provided, at its side coupled with the aeration compartment, with an annular groove perpendicular to the main shaft, into which an O-like sealing ring or a gasket is mounted.

Preferably, the main shaft uses materials with high magnetic permeability and low coercivity.

Preferably, the main shaft is provided with a shoulder or is mounted with an elastic shaft collar thereon for reliably axial positioning of the main shaft, the elastic shaft collar is located between the main shaft and the housing.

Preferably, both the permanent magnets and the poles are located between the two bearings.

Preferably, each permanent magnet is located between two of said poles 5, and the magnetic poles and the permanent magnets are mounted without gaps therebetween in the inner hole of the housing and remain gaps between them and the main shaft.

Preferably, the distance between an inner surface of the permanent magnet and the main shaft is larger than the distance between the pole teeth of the poles and the main shaft.

Preferably, spacer bushes of non-magnetic material are mounted between the poles and the bearings.

There exists relative movement between the main shaft and the housing of the present invention, and the main shaft is supported within the housing by bearings at the opposite ends. Since a magnetic circuit is constructed by the permanent magnet, the poles and the main shaft, under the action of the magnetic field generated by the permanent magnet, it is possible to allow the magnetic fluid placed at the gap between the main shaft and the pole to be concentrated and formed into O-like ring shaped structures having the same number as the pole teeth. The magnetic fluid of the O-like ring shaped structure will block up the gap between the main shaft and the poles, thus achieving the purpose of sealing.

### BRIEF DESCRIPTION OF THE DRAWINGS relative moving

FIG. 1 is a schematic view of the structure of a dynamic sealing device according to a first embodiment of the present invention;

FIG. 2 is a schematic view of the structure of a dynamic sealing device according to a second embodiment of the present invention;

FIG. 3 is a schematic view of the application of the dynamic sealing device according to the embodiment of the present invention;

FIG. 4 is a schematic view of the structure of a dynamic sealing device according to a third embodiment of the present invention;

FIG. 5 is a schematic view of the structure of a dynamic sealing device according to a fourth embodiment of the present invention;

FIG. 6 is a schematic view of the structure of a dynamic sealing device according to a fifth embodiment of the present invention.

### DETAILED DESCRIPTION OF THE INVENTION

A dynamic sealing device for a middle- or high-voltage power switch equipment is provided in the present invention, for meeting requirements for dynamic sealing of insulating medium of the middle- or high-voltage power switch equipment.

The core principle of the present invention is to make magnetic fluid to be formed into O-like ring shaped structures with the same number as that of pole teeth by a magnetic circuit constructed by a permanent magnet, the poles and the main shaft. The magnetic fluid of O-like ring shaped structures will block up the gap between a main shaft and poles so as to achieve the purpose of sealing.

Next, the present invention will be described in further detail in conjunction with the drawings and embodiments thereof to enable persons skilled in the art to better understand the solution of the present invention.

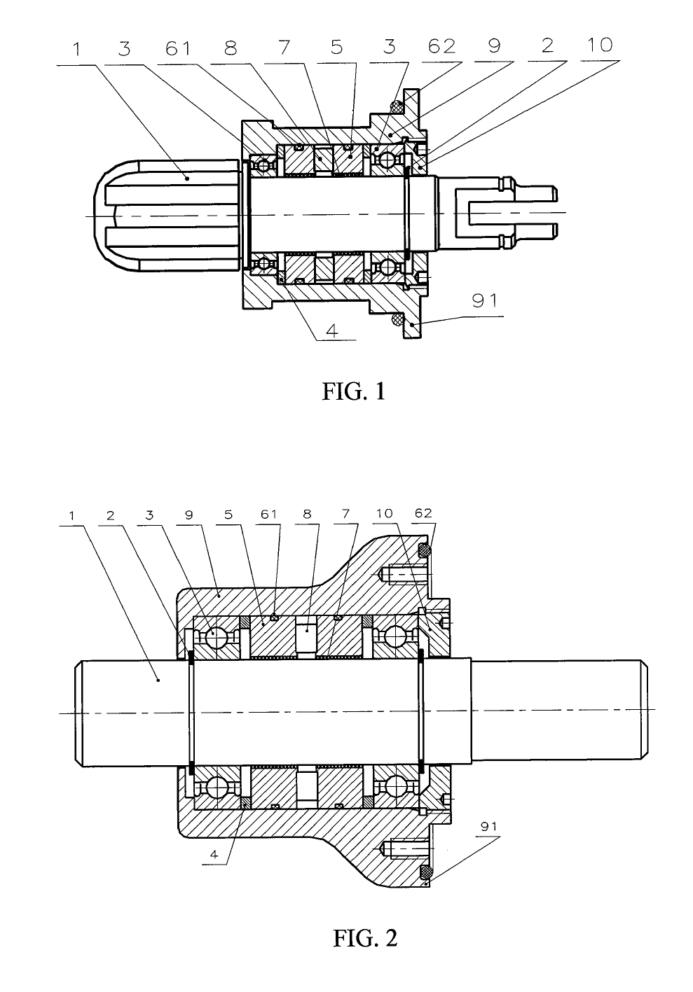

Referring to FIG. 1, a schematic view of the structure of a dynamic sealing device according to a first embodiment of the present invention is shown.

A dynamic sealing device for a middle- or high-voltage power switch equipment according to a first embodiment of the present invention includes: a housing 9, a cover 10 fitted with the housing 9; a main shaft 1 mounted inside the housing 9 and coupled with an acting mechanism (not shown in FIG. 1) inside an aeration compartment and an operating mechanism (not shown in FIG. 1) outside the aeration compartment; two bearings 3 for mounting the main shaft 1; and a permanent magnet 8 and two poles 5 being fitted into an inner hole of the housing 9 and having gaps between them and the main shaft, the two poles 5 being located at both sides of the permanent magnet 8, respectively. The dynamic sealing device for the middle- or high-voltage power switch equipment according to the first embodiment of the present invention further includes a first sealing ring 61 mounted on the outer circumference of the two poles 5 for ensuring static sealing and a second sealing ring 62 mounted on an outer wall 32 of a case of the aeration compartment. The poles 5 have a plurality of pole teeth. Magnetic fluid 7 is provided between the pole teeth of the poles 5 and the main shaft 1.

The poles 5 have a plurality of pole teeth on the inner surfaces thereof on a side close to the main shaft 1. Since magnetic force is strongest at the pole teeth, the magnetic fluid concentrates at tips of the pole teeth, such that O-like magnetic fluid sealing rings having the same number as the pole teeth are formed in the sealing gap and fully filled the sealing gap, therefore achieving the purpose of sealing.

The distance between an inner surface of the permanent magnet 8 and the main shaft 1 is larger than that between the pole teeth of the poles 5 and the main shaft.

The bearing 3 should enable the main shaft 1 to be reliably positioned radially and rotate freely inside the housing 9, while ensure the gap between the main shaft 1 and the magnet poles 5. In addition, the bearings 3 can allow the main shaft 1 to receive certain axial and radial loads. The permanent magnet 8 and the poles 5 are mounted between the two bearings 3.

The magnetic fluid is also known as magnetic liquid or ferrofluid. The magnetic fluid is a kind of liquid magnetic material, which can flow and is sensitive to magnetic field. It has not only the properties of magnetic material and liquid, but also the ability to control rheology behavior, thermophysical behavior and optical behavior through magnetic field.

The magnetic fluid is a gel solution of solid and liquid mixtures constructed by magnetic particles with nanometer-sized (from several nanometers to around a dozen nanometers) diameter uniformly dispersing and suspending in carrying liquid (base liquid added with surfactant) under the action of the surfactant. Both kinds of substance are mixed together to create a kind of new material having composite nature. Within a range of nanometer magnitude, this kind of material will not occur to a solid-liquid separation even under the action of gravity, centrifugal force and electromagnetic force and is a typical kind of nano-level composite material.

The main shaft 1 uses material with high magnetic permeability and low coercivity. The poles 5 use the same material as the main shaft 1. The housing 9 and the cover 10 may use non-magnetic material. The material used by the housing 9 and the cover 10 may be changed according to specific working environment.

The housing 9 and the cover 10 may be screw fitted or snap-fitted to each other. Of course, the housing 9 and the cover 10 may also corporate with each other by means of other mechanical fittings that are removable, which will not be described in detail herein.

There exists relative movement between the main shaft 1 and the housing 9 of the present invention, and the main shaft 1 is supported inside the housing 9 by bearings 3 at the opposite ends. Since a magnetic circuit is constructed by the permanent magnet 8, the poles 5 and the main shaft 1, it is possible to allow the magnetic fluid 7 placed at the gap between the main shaft 1 and the pole 5 to be concentrated and formed into a plurality of O-like ring shaped structure under the action of the magnetic field generated by the permanent magnet 8. The magnetic fluid 7 of the O-like ring shaped structure blocks up the gap between the main shaft 1 and the poles 5 and thus achieve the purpose of sealing.

The dynamic sealing device according to this embodiment of the present invention is suitable for positions that need dynamic sealing in various middle- or high-voltage power switch equipments, such as a SF₆-loaded switch, a breaker, an isolating switch, a Cubicle Gas Insulator Switchgear (C-GIS), a Gas Insulator Switchgear (GIS), etc, which use sulfur hexafluoride (SF₆) gas or nitrogen gas (N₂) or a gas mixture of both as the insulating medium to solve the problem of arc extinguishing.

The dynamic sealing device according to this embodiment of the present invention may apply the magnetic fluid 7 to various middle- or high-voltage power switch equipment to replace existing sealing means of rubber products or bellows, is suitable for various middle- or high-voltage power switch equipments and have magnetic field and mechanical structure with reasonable pressure-receiving conditions.

Furthermore, the dynamic sealing device according to this embodiment of the present invention is made of magnetic material that meets the requirements for mechanical movement of various middle- or high-voltage power switch equipments, and is capable of subjecting to various environmental temperature requirements of various middle- or high-voltage power switch equipments. In addition, it can also solve problems in dynamic sealing (including rotary dynamic sealing and linearly reciprocated dynamic sealing) for sulfur hexafluoride (SF₆) gas in various middle- or high-voltage power switch equipments.

In a preferable embodiment of the present invention, at a side of the main shaft 1 close to the cover 10, an elastic shaft collar 2 allowing reliable axial positioning of the main shaft 1 is mounted on the main shaft 1 and located between the main shaft 1 and the housing 9.

In a preferable embodiment of the present invention, spacer bushes 4 of non-magnetic material are mounted between the poles 5 and the bearings 3 for spacing the poles from the bearings, and thus avoiding dispersion of the magnetic field dispersion and magnetization of the bearings.

Referring to FIG. 2, a schematic view of the structure of a dynamic sealing device according to a second embodiment of the present invention is shown.

A flange 91 integrated with the housing 9 of a dynamic sealing device according to the second embodiment of the present invention is provided at its side coupled with the aeration compartment, with an annular groove perpendicular to the main shaft 1, in which a second sealing ring 62 is mounted. In contrast, a second sealing ring 62 is mounted on the outer wall of the case of the aeration compartment in the first embodiment.

In the dynamic sealing device according to the second embodiment of the present invention, axial positioning of the main shaft 1 is made by employing two elastic shaft collars, while in the first embodiment, the positioning of the main shaft is achieved relying on a shoulder and one elastic shaft collar.

To more clearly illustrate the working process of the dynamic sealing device according to an embodiment of the present invention, an explanation thereof will be given below in conjunction with specific application.

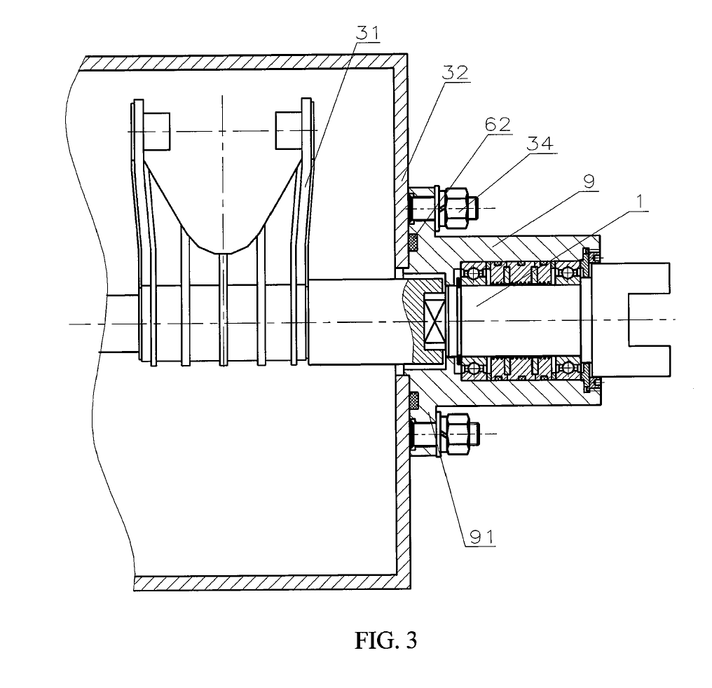

Referring to FIG. 3, a schematic view of the application of the dynamic sealing device according to an embodiment of the present invention is shown.

The main shaft 1 of the dynamic sealing device according to the embodiment of the present invention is coupled with an acting mechanism 31 inside the case of the aeration compartment supplied with sulfur hexafluoride (SF₆) gas and an operating mechanism (not shown in FIG. 3) in the atmosphere by means of splines, keys and planes, etc. designed on the shaft. The housing 9 of the magnetic fluid sealing device is coupled with the outer wall 32 of the case of the aeration compartment by means of screws 34, a pressing plate (not shown in FIG. 3), etc.

After other static sealing positions in the aeration compartment have been reliably sealed, the SF₆ gas in the aeration compartment has only two paths to leak out. One path through which the SF₆ gas leaks out is at the surface between the flange 91 of the dynamic sealing device and the outer wall 32 of the case of the aeration compartment. One O-like sealing ring 62 is disposed on the flange 91 of the housing 9 of the dynamic sealing device. Alternatively, this sealing ring may also be designed on the outer wall 2 of the case of the air compartment. Similarly, a static sealing such as a gasket may also be provided. The O-like sealing ring 62 is used to ensure that no SF₆ gas will leak out therethrough.

The other path through which the SF₆ gas leaks out is at the inner portion of the dynamic sealing device. Here, since the housing 9 of the dynamic sealing device is fixed and the main shaft 1 needs to rotate, the sealing thereof is a dynamic sealing. When used in dynamic sealing, conventional sealing means such as O-like sealing ring, skeleton oil seal and the like is not comparable with the magnetic fluid sealing in terms of various properties, such as, sealing property, resisting moment against the main shaft, service life, etc. Therefore, magnetic fluid is used at the dynamic sealing to ensure that the SF₆ gas will not leak out therethrough.

Through the above described dynamic and static sealings, the SF₆ gas can be reliably sealed within the case of the aeration compartment.

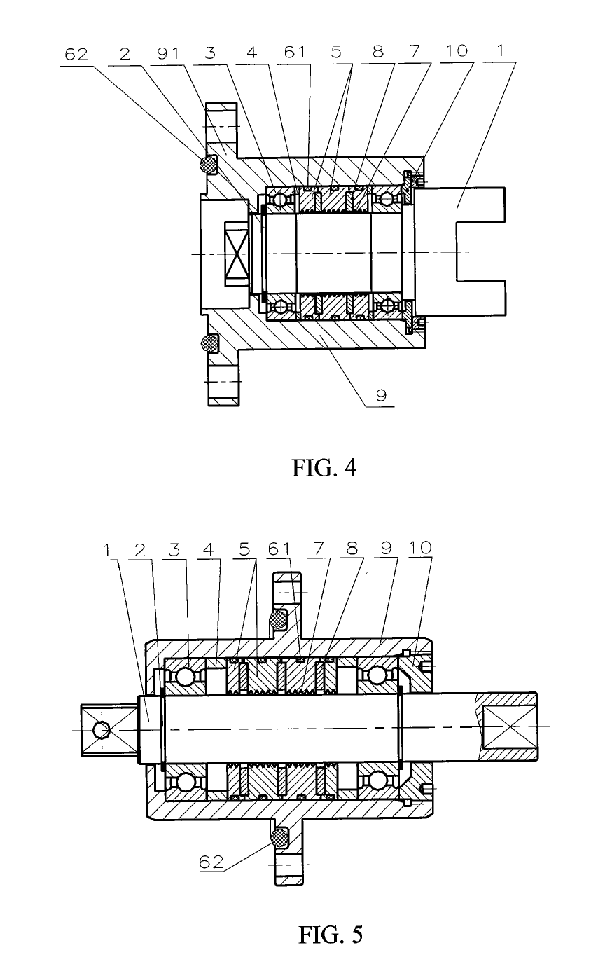

Referring to FIG. 4, a schematic view of the structure of a dynamic sealing device according to a third embodiment of the present invention is shown.

The dynamic sealing device according to the third embodiment of the present invention is different from the second embodiment in that the number of the permanent magnets 8 and the number of the poles 5 are different.

A dynamic sealing device according to the third embodiment of the present invention includes: a housing 9; a cover 10 fitted with the housing 9; a main shaft 1 mounted inside the housing 9 and coupling an acting mechanism (not shown in FIG. 4) inside the aeration compartment with an operating mechanism (not shown in FIG. 4) outside the aeration compartment; two bearings 3 for mounting the main shaft 1; and two permanent magnets 8 and three poles 5 mounted on the main shaft 1, wherein the three poles 5 being arranged alternately with the two permanent magnets 8, the two permanent magnets 8 being located between every two poles 5 among the three poles 5, and adjacent surfaces of the two permanent magnet 8 having same polarity. Each of the poles 5 has a plurality of pole teeth. Magnetic fluid is provided between the pole teeth of the three poles 5 and the main shaft 1.

The poles 5 have a plurality of pole teeth on the inner surfaces thereof on a side close to the main shaft 1. Since magnetic force is strongest at the pole teeth, the magnetic fluid concentrates at tips of the pole teeth, such that O-like magnetic fluid sealing rings having the same number as the pole teeth are formed in the sealing gap and fully filled the sealing gap, therefore achieving the purpose of sealing.

There exists relative movement between the main shaft 1 and the housing 9 of the present invention, and the main shaft 1 is supported inside the housing 9 by bearings 3 at the opposite ends. Since a magnetic circuit is constructed by two permanent magnets 8, three poles 5 and the main shaft 1, it is possible to allow the magnetic fluid 7 placed at the gap between the main shaft 1 and three poles 5 to be concentrated and formed into O-like ring shaped structures with the same number of the pole teech under the action of the magnetic field generated by the two permanent magnets 8. The magnetic fluid 7 of the O-like ring shaped structure blocks up the gap between the main shaft 1 and the poles 5 and thus achieve the purpose of sealing.

The number of the permanent magnets 8 and the poles 5 according to the present invention may be set according to different pressure of the aeration compartment.

Referring to FIG. 5, a schematic view of the structure of a dynamic sealing device according to a fourth embodiment of the present invention is shown.

The dynamic sealing device according to the fourth embodiment of the present invention is different from the third embodiment in that the number of the permanent magnets 8 and the number of the poles 5 are different.

According to the fourth embodiment of the present invention, the dynamic sealing device includes: a housing 9; a cover 10 fitted with the housing 9; a main shaft 1 mounted inside the housing 9 and coupling an acting mechanism (not shown in FIG. 4) inside the aeration compartment with an operating mechanism (not shown in FIG. 4) outside the aeration compartment; two bearings 3 for mounting the main shaft 1; and three permanent magnets 8 and four poles 5 mounted on the main shaft 1, wherein the four poles 5 being arranged alternately with the three permanent magnets 8, the three permanent magnets 8 being located between the outermost two poles 5 among the four poles 5, and adjacent surfaces of every two permanent magnets having same polarity. Each of the poles 5 has a plurality of pole teeth. Magnetic fluid is provided between the pole teeth of the four poles 5 and the main shaft 1.

Also, the poles 5 have a plurality of pole teeth on the inner surfaces thereof on a side close to the main shaft 1. Since magnetic force is strongest at the pole teeth, the magnetic fluid concentrates at tips of the pole teeth, such that a plurality of O-like magnetic fluid sealing rings are formed in the sealing gap and fully filled the sealing gap, therefore achieving the purpose of sealing.

There exists relative movement between the main shaft 1 and the housing 9 of the present invention, and the main shaft 1 is supported inside the housing 9 by bearings 3 at the opposite ends. Since a magnetic circuit is constructed by three permanent magnets 8, four poles 5 and the main shaft 1, it is possible to allow the magnetic fluid 7 placed at the gap between the main shaft 1 and four poles 5 to be concentrated and formed into a plurality of O-like ring shaped structures under the action of the magnetic field generated by the three permanent magnets 8. The magnetic fluid 7 of the O-like ring shaped structure blocks up the gap between the main shaft 1 and the poles 5 and thus achieve the purpose of sealing.

The number of the permanent magnets 8 and the poles 5 according to the present invention may be set according to different pressure of the aeration compartment. It is required that the number of the permanent magnets 8 and the poles 5 according to the present invention should ensure that each of the permanent magnets 8 is located between two said poles 5, and that the poles and the permanent magnets are preferably mounted without gaps therebetween in the inner hole of the housing 9 and remain gaps from the main shaft 1.

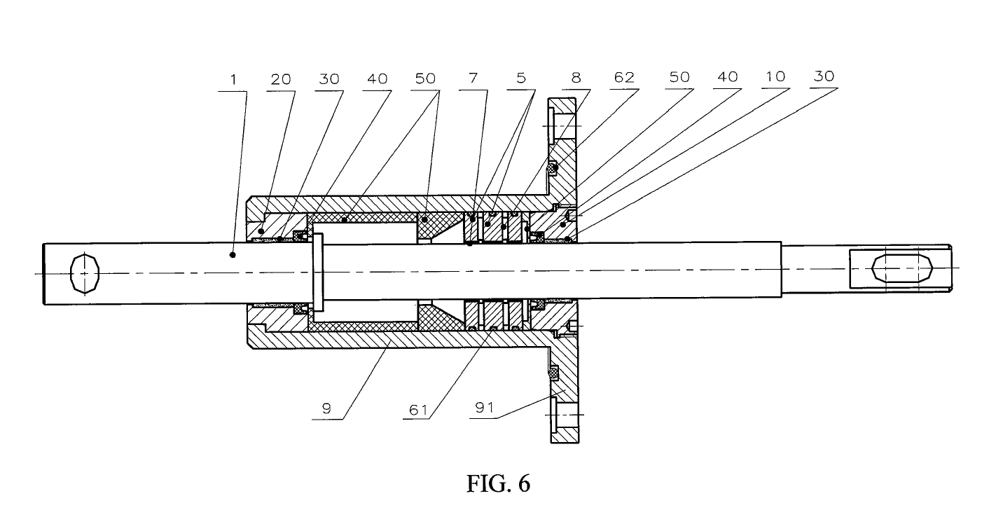

Referring to FIG. 6, a schematic view of the structure of a dynamic sealing device according to a fifth embodiment the present invention is shown.

The dynamic sealing device according to the fifth embodiment of the present invention is different from the above four embodiments in that the dynamic sealing device described in the fifth embodiment of the present invention is a linearly reciprocated magnetic fluid sealing piece for ensuring that the gas within the aeration compartment does no leak through the sealed position when the main shaft 1 is linearly reciprocated in an axial direction.

The portion of the dynamic sealing consists of the poles 5 and the permanent magnets 8. The inner holes of the poles 5 have pole teeth, and the outer circumferences thereof have annular grooves into which a first sealing ring is mounted.

The dynamic sealing device according to this embodiment of the present invention includes a main shaft 1, which couples an acting mechanism inside the aeration compartment with an operating mechanism outside the aeration compartment and forms a magnetic circuit together with the permanent magnets 8 and the poles 5.

The dynamic sealing device according to this embodiment of the present invention further includes: Y-like sealing rings 40 and linear bearings 30 that are mounted on the main shaft 1; and bearing brackets 20 for ensuring that the linear bearings 30 function to radially position the main shaft 1. The linear bearings 30 enable the main shaft 1 to be radially positioned inside the housing 9 in a reliable manner and to rotate freely, while ensure the sealing gap between the main shaft 1 and the magnet poles 5 and enable the main shaft 1 to receive certain radial loads. The Y-like sealing ring 40 prevents the magnetic fluid 7 inside from being brought out when the main shaft 1 is linearly reciprocated.

The dynamic sealing device according to this embodiment of the present invention further includes spacer bushes 50, which ensure that the poles 5 and the permanent magnets 8 are located at certain sealing positions, limit the strike of the main shaft 1 when it is reciprocated and buffer axial impact generated when the main shaft 1 is reciprocated.

The dynamic sealing device according to this embodiment of the present invention further includes a second sealing ring 62 for ensuring sealing of the static sealing positions.

The dynamic sealing device according to this embodiment of the present invention further includes a cover 10, which has, on its outer circumference, screws cooperating with the housing 9, ensures reliable axial positioning of all inside parts, allows for mounting of the linear bearing 30 and the Y-like ring 40, and ensures that the linear bearing 30 functions to radially position the main shaft 1.

The housing 9 and the cover 10 may be screw fitted or snap-fitted to each other. Of course, the housing 9 and the cover 10 may also corporate with each other by means of other mechanical fittings that are removable, which will not be described in detail herein.

The inner hole of the pole 5 as described above in various embodiments may not have pole teeth. Instead, the pole teeth may be produced integrally with the main shaft 1.

The dynamic sealing device according to embodiments of the present invention is a non-contact sealing, or referred to as liquid and solid contact sealing. Using magnetic fluid dynamic sealing in place of conventional dynamic sealing eliminates mutual friction between dynamic sealing parts, and eliminate the problem of wear failure at the solid-solid interfaces between sealing parts and the main shaft 1 in conventional sealing. The dynamic sealing device according to embodiments of the present invention may maintain original sealing state for a long period of time and thus prolong service life.

Based on a large number of dynamic and static tests taken by the applicant, no leakage can be easily detected even using helium mass spectrometer leak detector at 1×10⁻¹¹ Pa.m³/s. Therefore, the dynamic sealing device according to embodiments of the present invention is operated substantially without leakage.

According to measurement taken by the applicant, the sealing ring of each stage of the O-like ring shaped structure has a pressure differential of 0.02 to 0.035 MPa, and the total pressure differential for the sealing may be up to 1.5 to 2 MPa.

The dynamic sealing device according to embodiments of the present invention is applicable within a wide range of temperature. It is generally applicable in an environment at a temperature of −40 to 100° C., and may meet requirements for various outdoor environments where the middle- or high-voltage power switch equipment is arranged.

Arc extinguishing and switching on/off of the dynamic sealing device according to embodiments of the present invention can be performed integrally and synchronously.

Considering that the middle- or high-voltage power switch equipment is characterized by automatic on-off operation, through a large number of experiments, the dynamic sealing device according to embodiments of the present invention has optimized its design and may transmit mechanical working torque at the same time of sealing and lubricating. This function is absolutely impossible in conventional sealing. Therefore, the present invention has a safe and efficient advantage of performing the arc extinguishing, switching on and off of the dynamic sealing device integrally and synchronously.

The above description are only preferred embodiments of the present invention, it should be noted that various changes and modifications can be made without departing from the principle of the present invention for ordinary persons skilled in the art and should also be conceived as within the scope of protection of the present invention.

1. A dynamic sealing device for a middle- or high-voltage power switch equipment, characterized by comprising: a housing, a cover fitted with the housing, a main shaft mounted within the housing and coupling an acting mechanism inside an aeration compartment and an operating mechanism outside the aeration compartment, two bearings for mounting the main shaft, and at least one permanent magnet and at least two poles being fitted to an inner hole of the housing and having gaps between them and the main shaft, wherein, the two poles are located on both sides of the permanent magnet respectively and have a plurality of pole teeth, and magnetic fluid is provided between the pole teeth of the poles and the main shaft.

2. The dynamic sealing device according to claim 1, characterized in that, the pole has pole teeth on the inner surfaces thereof on a side close to the main shaft, and the magnetic fluid is located between the pole teeth and the main shaft.

3. The dynamic sealing device according to claim 1 or 2, characterized in that, the poles are provided, at outer surfaces thereof on a side close to the inner hole of the housing, with an annular groove perpendicular to the main shaft into which an O-like sealing ring is mounted.

4. The dynamic sealing device according to claim 3, characterized in that, the housing further includes a flange integral with the housing, the flange is provided, at a side thereof coupled with the aeration compartment, with an annular groove perpendicular to the main shaft, into which an O-like sealing ring or a gasket is mounted.

5. The dynamic sealing device according to claim 3, characterized in that, the main shaft uses materials with high magnetic permeability and low coercivity.

6. The dynamic sealing device according to claim 3, characterized in that, the main shaft is provided with a shoulder or is mounted with an elastic shaft collar thereon for a reliable axial positioning of the main shaft, the elastic shaft collar is located between the main shaft and the housing.

7. The dynamic sealing device according to claim 3, characterized in that, both the permanent magnets and the poles are located between the two bearings.

8. The dynamic sealing device according to claim 7, characterized in that, each permanent magnet is located between two of said poles, and the magnetic poles and the permanent magnets are mounted without gaps therebetween in the inner hole of the housing and remain gaps between them and the main shaft.

9. The dynamic sealing device according to claim 7, characterized in that, the distance between an inner surface of the permanent magnet and the main shaft is larger than the distance between the pole teeth of the poles and the main shaft.

10. The recording medium accumulating device according to claim 7, characterized in that, spacer bushes of non-magnetic material are mounted between the poles and the bearings.
